(19) United States
(12) Patent Application Publication
(10) Pub. No.: US 2010/0199514 A1
(43) Pub. Date: Aug. 12, 2010

(54) OPTIMIZED APPARATUS AND METHOD FOR MANURE MANAGEMENT

(75) Inventor: TIMOTHY CAMISA, COLCHESTER, VT (US)

Correspondence Address: AKC PATENTS, 215 GROVE ST., NEWTON, MA, 02466, US

(73) Assignee: VERMONT ORGANICS RECLAMATION INC., WILLISTON, VT (US)

(21) Appl. No.: 12/702,487

(22) Filed: Feb. 9, 2010

Related U.S. Application Data
(60) Provisional application No. 61/151,331, filed on Feb. 10, 2009.

(51) Int. Cl. F26B 23/02; F26B 3/24; F26B 13/30; F26B 3/04

(52) U.S. Cl. 34/201; 34/92; 34/520

(57) ABSTRACT

An improved system for processing a liquid manure and producing organic fertilizer includes equipment for separating various solid components of the liquid manure having different nitrogen to phosphorous ratios and then mixing these components so as to produce an organic fertilizer with a predetermined nitrogen to phosphorus ratio. The system includes equipment for separating solid manure components and clarified water. Solid manure components include fertilizer, fodder/bedding material, and biomass. Fertilizer and clarified water are used to fertilize and irrigate the farming soil. Fodder is used as a bedding material for the animals or as a feed source. Biomass is used as a fuel source for running farming equipment and processes that require energy.

### CROSS REFERENCE TO RELATED CO-PENDING APPLICATIONS

This application claims the benefit of U.S. provisional application Ser. No. 61/151,331 filed on Feb. 10, 2009 and entitled OPTIMIZED APPARATUS AND METHOD FOR MANURE MANAGEMENT which is commonly assigned and the contents of which are expressly incorporated herein by reference.

### FIELD OF THE INVENTION

The present invention relates to an optimized apparatus and a method for manure management, and more particularly to a manure management system that integrates a manure treatment system and a custom fertilizer production system.

### BACKGROUND OF THE INVENTION

In the northern parts of the United States, dairy cattle are confined in dairy farms and fed with phosphate-rich feed during the long winter periods. During this long period of confinement, that lasts from the early fall until the early spring, the “in barn” produced manure accumulates in the farm. Similarly, poultry-based farms produce different but sometimes more concentrated manure. The concentrated manure from the dairy farms, the poultry farms or any other type of animal farms is usually stored outside of the barn in a manure pit and then spread over the fields in the spring. Government agencies have recommended this practice of spreading of manure over fields during spring as a method of disposing of agricultural waste while fertilizing the ground. This practice has led to purchase, maintenance and paying of taxes on 1 and that is kept primarily for manure overspread, which is a major financial burden for the farmers.

Manure is composed of 96% water and of 4% solid nutrient materials. In other words, unprocessed manure is a very dilute source of fertilizing nutrients. Furthermore, studies have shown that phosphorous and other nutrients present in manure are water soluble, which causes these nutrients to be washed out by rain or snow. Therefore one ton of manure yields only 7 to 10 pounds of nutrients to the ground.

Spreading of manure is not allowed during the winter months on top of snow to prevent runoff of phosphates and other contaminants to nearby rivers, lakes and other groundwater systems with the melting of the snow. However, the process of spreading of the concentrated manure in the spring still causes excess runoff of phosphates and other contaminants to nearby rivers, lakes and other groundwater systems. Agricultural runoff, rich in nutrients like phosphorus and nitrogen has been linked to toxic microorganisms. These microorganisms are known to kill and/or cause diseases in fish and other animals and pose a serious health risk to humans.

Typical dairy manure contains nitrogen (N) and phosphorous (P) at a ratio of 3 to 1. The optimum fertilizer ratio of N:P for growing corn is 8 to 1. Therefore, the farmer has to spread in addition to the manure a large amount of urea for adding nitrogen in order to generate the required 8 to 1 ratio of N:P in the ground. Other plants require different ratios of N:P and the amount and type of additives need to be modified accordingly. This process of adding and spreading urea or other additives increases both the labor and material cost of farming and requires that the farmer goes out in the fields several times during the year.

As was mentioned above, phosphorus is water soluble which leads to phosphorus being washed out from the manure pit and soil by rain and carried to rivers, lakes and other groundwater systems, thereby causing pollution and reducing the fertilizing value of the manure. Also, nitrogen evaporates from the manure pit as ammonia which generates undesirable odors and causes the concentration of insects and vermin, while again reducing the fertilizing value of the manure.

Several prior art methods have been suggested for treating manure on the barn site and for converting manure to fertilizer. However, most of the prior art methods are not efficient, not scalable, or not economical and may require the addition of other chemicals for producing fertilizer.

Accordingly, there is a need for an efficient, scalable, economically viable and environmentally friendly process and system for treating manure and for producing stable custom fertilizer without the need to add chemicals.

### SUMMARY OF THE INVENTION

The invention features an improved system and method for processing liquid manure that includes transferring the liquid manure among a plurality of processing stations in a predetermined sequence for producing organic fertilizer. The system includes equipment for separating various solid components of the liquid manure having different nitrogen to phosphorous ratios and then mixing these components so as to produce an organic fertilizer with a predetermined nitrogen to phosphorus ratio. The system also includes equipment for clarifying water. In addition to fertilizer, the solid manure components include fodder/bedding material and biomass. The manure processing system is part of a sustainable farming process where the fertilizer and clarified water are used to fertilize and irrigate the farming soil, fodder is used as a bedding material for the animals or as a feed source and biomass is used as a fuel source for running farming equipment and processes that require energy.

In general, in one aspect, the invention features a system for processing liquid manure including a series arrangement of a plurality of equipment. The series arrangement includes first, second, third, fourth, fifth, sixth and seventh equipment. First equipment transfers the liquid manure into an input station. Second equipment separates a first manure component and a first overflow liquor from the liquid manure at a first processing station. Third equipment adds a flocculant material to the first overflow liquor at the first processing station. Fourth equipment mechanically separates a second manure component and a second overflow liquor from the first overflow liquor at a second processing station. Fifth equipment performs direct current electrocoagulation cleaning of the second overflow liquor at a third processing station and separates a third manure component and a third overflow liquor. Sixth equipment performs clarifying cleaning of the third overflow liquor at an output station and separates a fourth manure component and water. The sixth equipment comprises an outer container, an inner container contained within the outer container and having a bottom communicating with the outer container's bottom, means for transferring the third overflow liquor into the inner container, means for centrifuging the third overflow liquor in the inner container, means for extracting the fourth manure component from the centrifuged third overflow liquor through the inner container bottom, means for depositing the extracted fourth manure component at the bottom of the outer container, means for extracting the water from the centrifuged third overflow liquor and means for pushing the extracted water to the sides of the outer container in the space between the inner and outer container. The seventh equipment dries any of the manure components and produces dried manure components. The drying equipment comprises a stationary inner container surrounded by a rotating outer container, means for introducing hot air in the space between the inner container and the outer container, means for transferring the manure components into the inner container, means for rotating the outer container around and concentrically with the inner container and means of generating hot air. The means for generating hot air comprises a generator fueled by burning the dried manure components.

Implementations of this aspect of the invention may include one or more of the following features. The system may further include equipment for homogenizing the liquid manure at the input station and/or equipment for discharging the water from the output station. The flocculant material may be a complex carbohydrate compound. The complex carbohydrate compound may be Fycosyllactose (C₁₈H₃₂O₁₅), Difucosyllactose (C₂₄H₄₂)₁₉), Lacto-N-tetraose (C₂₆H₄₅NO₂₁), Lacto-N-fucopentaose I (C₃₂H₅₅NO₂₅), Lacto-N-difucohexaose I (C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₀H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3, Oligomannose-8D1D2 (C₆₄H₁₀₈N₂O₅₁), Oligomannose-8D2D3, Oligomannose-9 (C₇₀H₁₁₈N₂O₅₆), Asialo-biantennary (C₆₂H₁₀₄N₄O₄₆), Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, or Maltotriose. The second equipment for separating a first manure component may be a screw press. The fourth equipment for separating a second manure component may be a plate filter press. The flocculant may be lime, iron, aluminum, wollostonite, calcium, starches, proteins, gelatin, animal glue, polymeric compounds or food grade polymers. The system may further include equipment for thickening the liquid manure. The system first manure component may comprise about 15 percent soluble phosphorus and about 20 percent soluble nitrogen. The second manure component may comprise about 40 percent partially soluble phosphorus and about 30 percent partially soluble nitrogen. The third manure component may comprise about 45 non-soluble phosphorus and about 10 percent non-soluble nitrogen. The fourth manure component may comprise about 40 percent non-soluble nitrogen and no phosphorous. The arrangement may further include eighth equipment for adding a stabilizing component to any of the manure components. The stabilizing component may be lime, wollostonite, calcium carbonate, complex carbohydrates, or calcium. The arrangement may further include ninth equipment for mixing a first amount of the first manure component, a second amount of the second manure component, a third amount of the third manure component and/or a fourth amount of the fourth manure component to obtain a fertilizer comprising a desired nitrogen to phosphorous ratio.

In general, in another aspect, the invention features an apparatus for drying wet solid manure and producing dried manure. The drying apparatus includes a stationary inner container surrounded by a rotating outer container, means of generating hot air, means for introducing the hot air in the space between the inner container and the outer container, and means for transferring the wet solid manure into the inner container. The outer container rotates around and concentrically with the inner container. The means for generating hot air comprises a generator fueled by burning the dried manure.

In general, in another aspect, the invention features a sustainable farming process including processing liquid manure with the system of claim 1 thereby producing the first, second, third and fourth manure components, clarified water and dried manure components. Next, mixing a first amount of the first manure component, a second amount of the second manure component, a third amount of the third manure component and/or a fourth amount of the fourth manure component to obtain a custom fertilizer comprising a desired nitrogen to phosphorous ratio. Next, fertilizing farming soil with the custom fertilizer and then irrigating the farming soil with the clarified water. Finally, burning the dried manure components in a generator for generating power.

Among the advantages of this invention may be one or more of the following. The improved system for manure processing shortens the manure processing cycle to 4 hours per cycle. The method is scalable, low cost, efficient and environmentally friendly.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a diagrammatic view of the manure reclamation system of this invention;

FIG. 2 is a block diagram of the manure reclamation process and the fertilizer production process;

FIG. 3 is a schematic diagram of the clarifier of FIG. 1;

FIG. 4 is a schematic diagram of the drier;

FIG. 5 is a block diagram of a sustainable farming process;

FIG. 6 is a schematic diagram of an integrated manure management system;

FIG. 7 is a schematic diagram of a conventional farming process; and

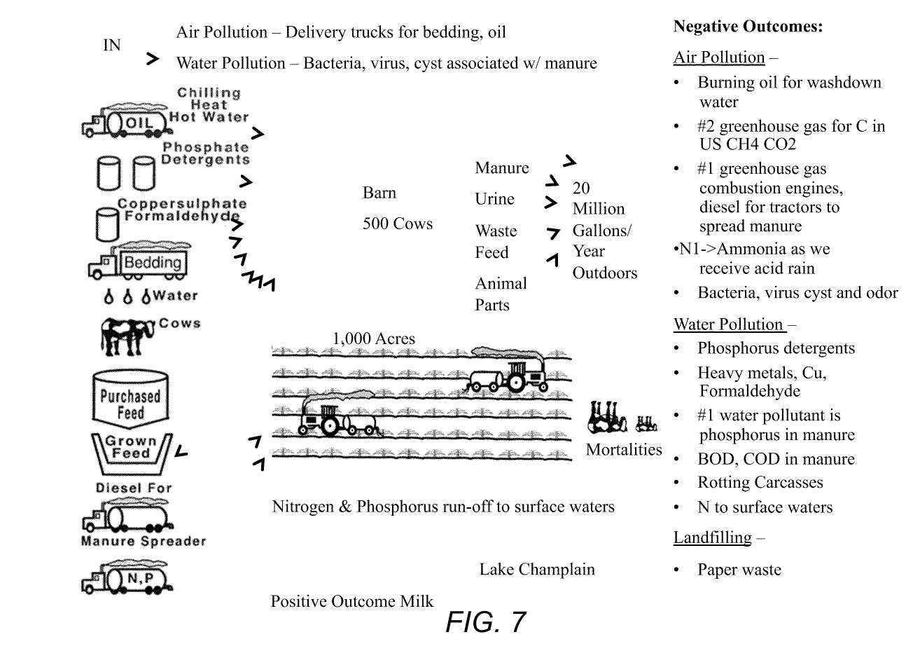

FIG. 8 is schematic diagram of the sustainable farming process of FIG. 5.

### DETAILED DESCRIPTION OF THE INVENTION

The invention features an optimized system and method for processing liquid manure and producing organic fertilizer. The system includes equipment for separating various components of the liquid manure having different nitrogen to phosphorous ratios and then mixing these components so as to produce an organic fertilizer with a predetermined nitrogen to phosphorus ratio. The invention also features a sustainable farming process.

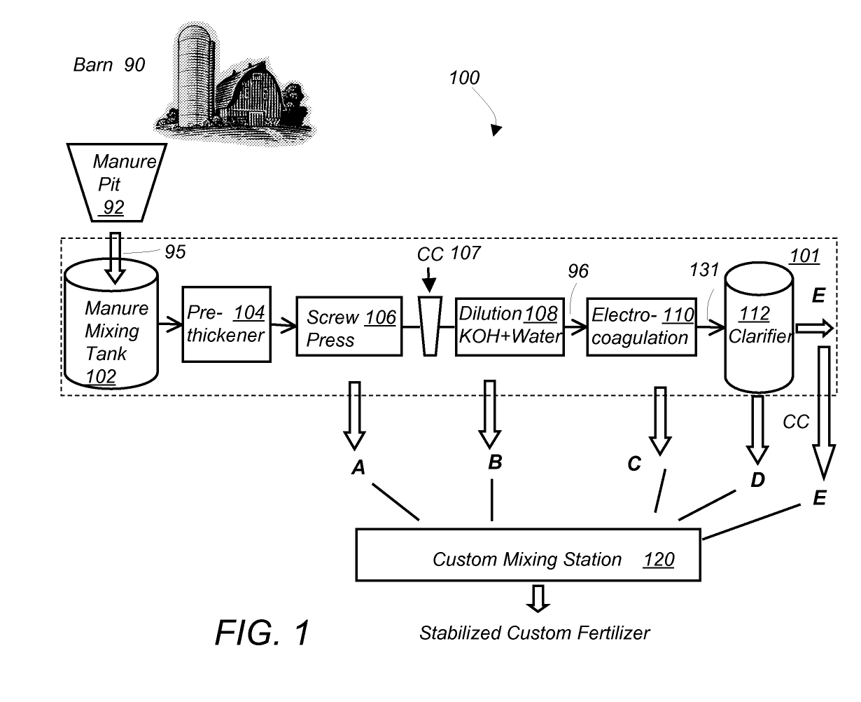

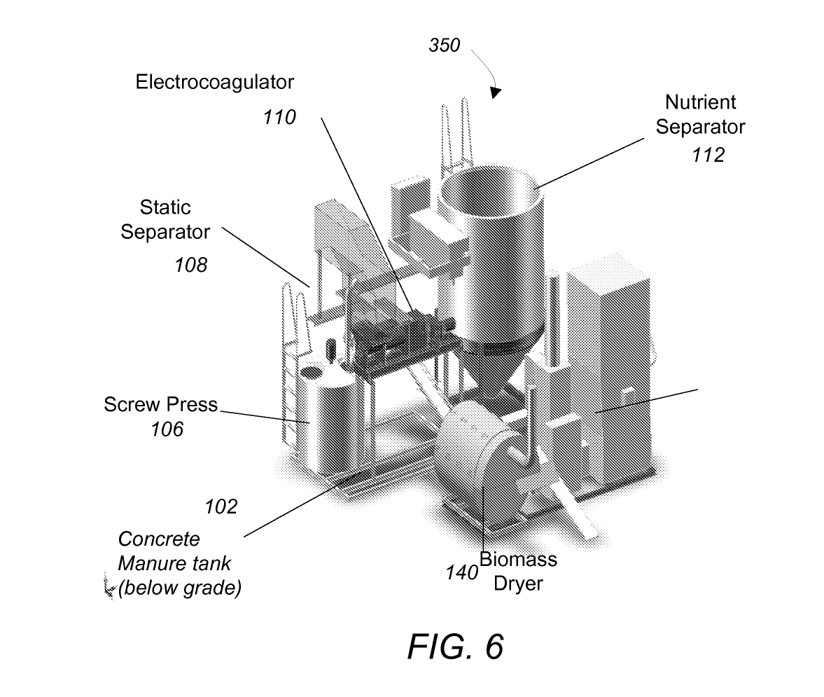

Referring to FIG. 1 and FIG. 6, a manure reclamation system 100 includes a manure treatment system 101 and a fertilizer production system 120. Manure 95 that accumulates in a manure pit 92 on the barn site 90 is introduced into a manure mixing tank 102. The manure 95 at this stage is in liquid form and is composed of about 92% to 96% water and 4% to 8% solids. The solids include, in addition to the dissolved manure, animal byproducts, such as pieces of tail, cow ears, nails, bedding, placenta, hair, grains, sand and other small particles. Several nutrients are dissolved in the water including phosphorus (P), nitrogen (N) and potassium (K), among others. The manure treatment process 101 includes separation of liquids from solids, collection of the separated solid materials at the various stages and treatment of the remaining liquid so that it can be discharged back into the fields. In the mixing tank 102 the big undissolved solid pieces are removed from the liquid manure and the remaining mixture is stirred in order to form a homogenous mixture. The liquid manure 95 leaves the mixing tank 102 and enters a pre-thickener station 104. The pre-thickener station 104 includes a stainless steel screen that strains and removes the excess water out. Next, the manure 95 passes through a screw press station 106. The screw press 106 separates the sludge component A from the manure. The sludge component A contains the best quality of manure, also called “cake”. The “cake” contains about 15% soluble P and 20% soluble N and it can be directly injected into the ground for fertilizing purposes. The “cake” is excellent for aerating clay type soils and the process of injecting the “cake” introduces the nutrients deep into the soil at about 4 to 8 inches depth from the surface.

Next, the remaining liquid manure solution is emptied into a container 107 and a flocculant component is added. The flocculant component is usually a mixture of inorganic and organic compounds. Inorganic flocculant compounds include iron, aluminum and minerals such as lime and wollostonite. Organic flocculant compounds include starches, proteins, gelatin, animal glue, polymeric compounds, and food grade polymers. A class of organic flocculant compounds that has been found to be especially efficient are complex carbohydrates (CC). Examples of complex carbohydrates include Fycosyllactose (C₁₈H₃₂O₁₅), Difucosyllactose (C₂₄H₄₂)₁₉), Lacto-N-tetraose (C₂₆H₄₅NO₂₁), Lacto-N-fucopentaose I (C₃₂H₅₅NO₂₅), Lacto-N-difucohexaose I(C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₀H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3, Oligomannose-8D1D2 (C₆₄H₁₀₈N₂O₅₁), Oligomannose-8D2D3, Oligomannose-9 (C₇₀H₁₁₈N₂O₅₆), Asialo-biantennary (C₆₂H₁₀₄N₄O₄₆)₅ Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, and Maltotriose. These complex carbohydrates are produced by GlycoTech, Gaithersburg, Md. 20879. Typical amounts of flocculants used are 1 gram per liter of manure. In addition to their role as flocculants, the complex carbohydrates contribute to electrically stabilizing the irrigation water so that Nitrogen remains in the solution and does not evaporate. Furthermore, complex carbohydrates form enzymes that further stabilize the soil from further leaching.

After the addition of the flocculant component the manure solution enters a second mixing tank 108. In the mixing tank 108 the manure solution is further diluted with KOH and water to 1:1 ratio. In one example, 500 gallons of water and KOH are added to 500 gallons of manure solution. The KOH reacts with the phosphorus in the manure solution to form KPO4, which is a stable fertilizer. The addition of KOH increases the solid content of the manure solution and raises the ph of the solution. The increased ph value improves the effect of the following electrocoagulation step.

Next, the diluted manure solution passes trough an electrocoagulation station 110. Electrocoagulation station 110 includes at least two metal plate electrodes (an anode and a cathode) that are connected to a DC current electrical source. The two most common plate materials are iron and aluminum. In accordance with Faraday's law, metal ions are split off or sacrificed into the liquid medium. These metal ions tend to form metal oxides that electromechanically attract to the various water contaminants. The electrocoagulation process destabilizes the suspended, emulsified or dissolved contaminants, attaches them to the metal ions and metal oxides and then carries them to the plate with the opposite charge. Generally, this state of stability produces a solid that is either less colloidal and less emulsified (or soluble) than the compound at equilibrium values. As this occurs, the contaminants form hydrophobic entities that precipitate and can easily be removed by a number of secondary separation techniques. Electrocoagulation removes all remaining unreacted phosphorous while leaving behind as much nitrogen as possible. Electrocoagulation also removes heavy metals, oxides, suspended colloidal solids, fats, oils, grease, and complex organic materials. Electrocoagulation also breaks oil emulsions and destroys and removes bacteria, viruses, cyst, microbia and other pathogenic microorganism.

Finally the remaining liquid passes through an atmospheric clarifying station 112, where the remaining insoluble components are separated from the water E. Water solution D contains 40% of insoluble N, KPO4 and no P. The nitrogen rich water solution D is further stabilized by adding CC and converting it into nitrate. Water E is free of any phosphorus, meets EPA standards for phosphorous surface release and is used for irrigation and as a fertilizer base of the surrounding fields. Water E may be collected in a perc pond or used for inground infiltration.

Referring to FIG. 6 and FIG. 1, an equipment system 350 for processing liquid manure includes a series arrangement of equipment including first equipment 95 for transferring manure in the manure tank 102, second a screw press 106 for separating a first manure component, third equipment 107 for adding a flocculant material to the first overflow liquor produced by the screw press 106, fourth a static separator 108 for separating a second manure component, fifth an electrocoagulator 110 for performing direct current electrocoagulation cleaning and producing a third manure component, sixth a clarifier/nutrient separator 112 for producing a fourth manure component and clarified water, and a biomass dryer 140 for drying any of the above mentioned manure components or mixtures thereof.

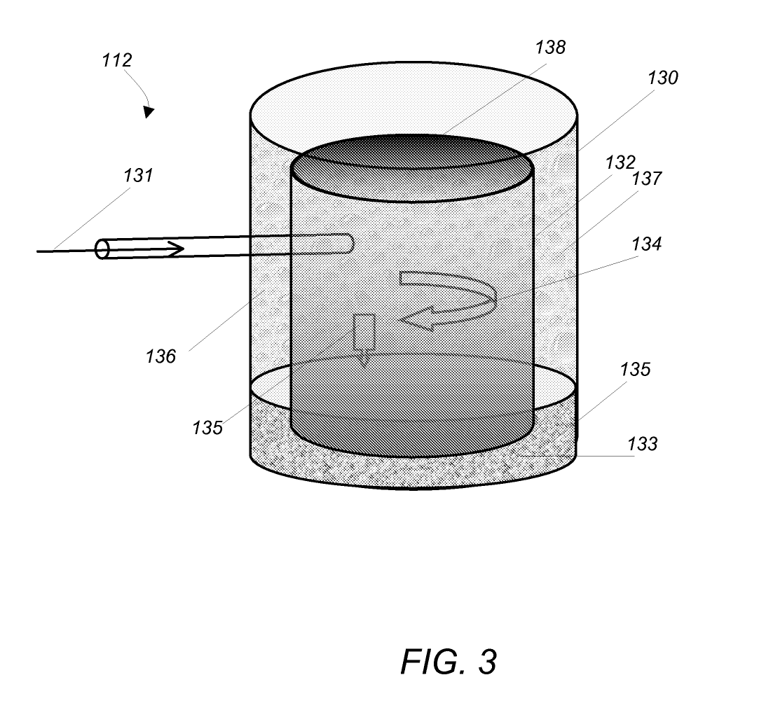

Referring to FIG. 3, clarifier 112 includes an inner container 132 contained within an outer container 130. Inner container 132 communicates with the outer container 130 at the bottom 133. The manure solution 131 from the electrocoagulation station 110 is introduced into the inner container 132 where it is centrifuged so that the solid components 135 are separated and deposited in the bottom of the communicating inner and outer containers and the remaining clarified water 136 is pushed to the sides 137 of the outer container 130 in the space between the inner and outer containers. Carbon foam 138 floats on the top surface of the manure solution in the inner container 132.

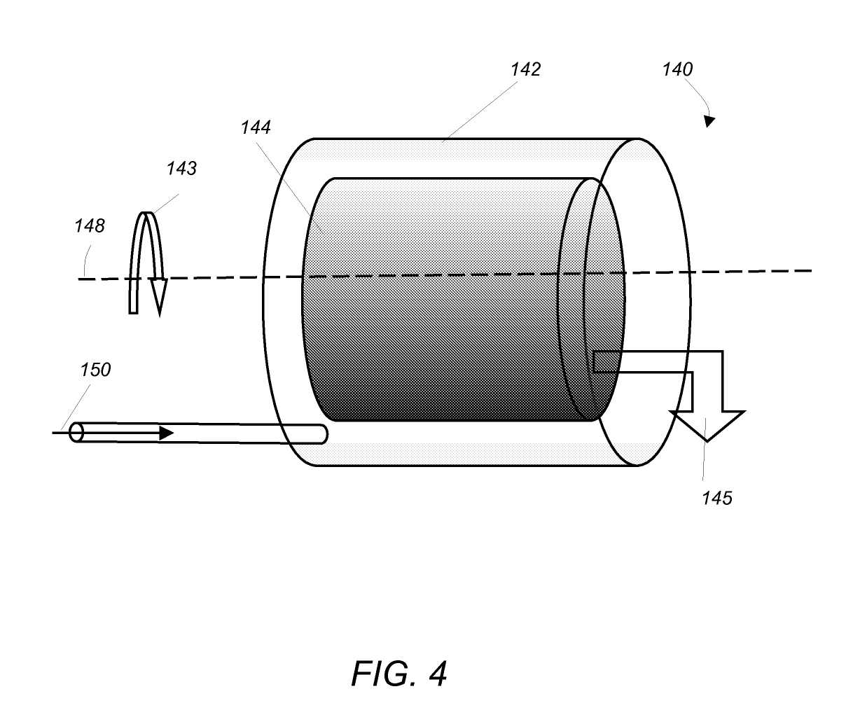

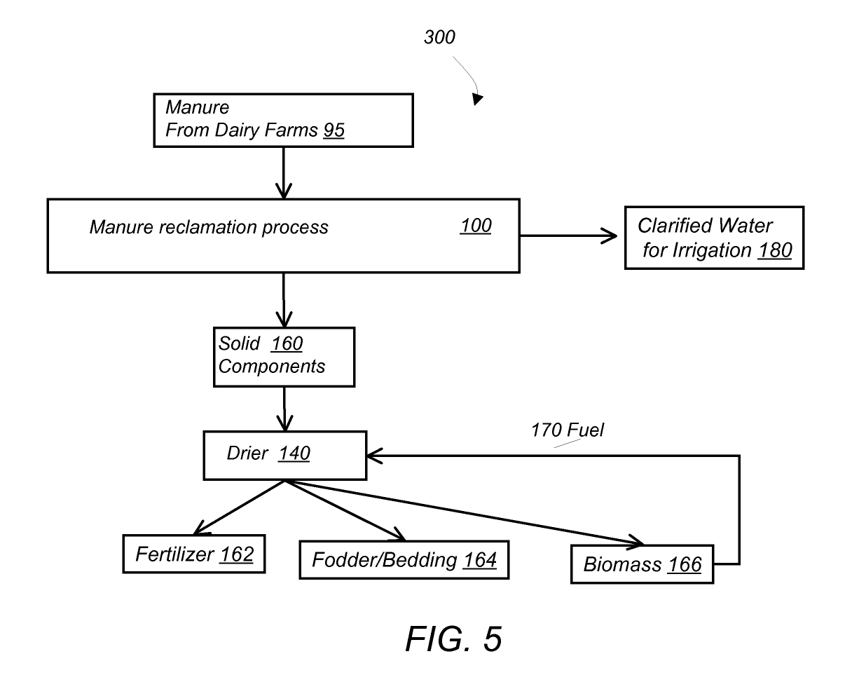

Any of the extracted wet manure components A, B, C or D is further introduced in a drying station 140, shown in FIG. 4 and FIG. 6. Drying station 140 includes an inner stationary drum 144 and an outer rotating drum 142 surrounding the inner drum 144. Inner drum 144 is arranged concentric with the outer drum and both drums are oriented horizontally along axis 148. Outer drum 142 rotates clockwise 143 or counter-clockwise around axis 148. Hot air 150 is introduced in the space between the inner and outer drums for drying the wet components A, B, C, or D. Manure components A, B, C or D are heated to a temperature of about 150° F. for about 20 minutes for drying and sterilization purposes. The atmosphere within the inner drum may also be evacuated 145 during the drying process to remove excess moisture and thereby to speed up the drying process. In another embodiment the dried manure components exiting the drier 140 are used to fuel the drying process 170, as shown in FIG. 5.

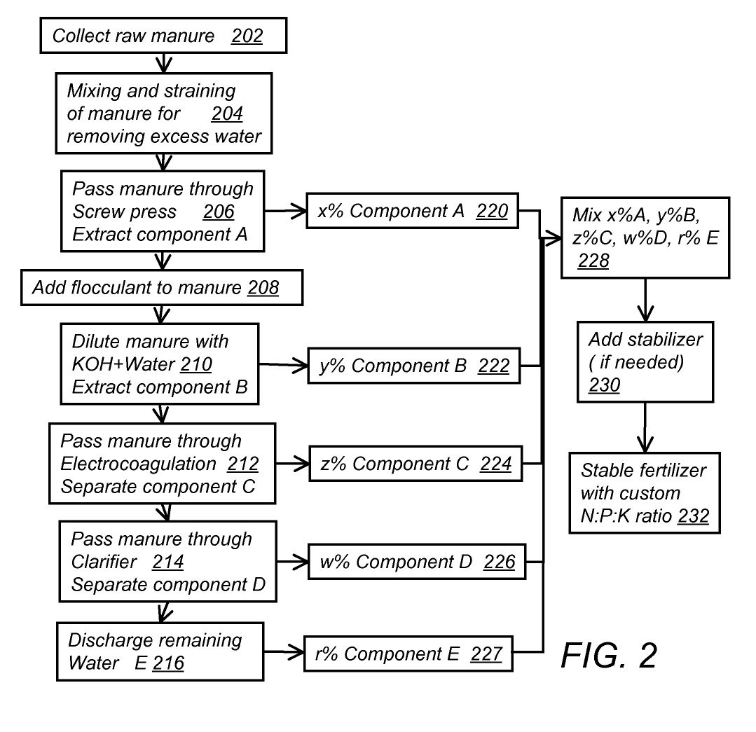

As was mentioned, the fertilizer composition depends upon the composition of the soil and the type of plant that the farmer wants to grow on the particular soil. For example, for clay-type soil, a fertilizer composed of component A is suitable. For sandy type of soil a fertilizer composed of component B is suitable. At the same time, in order to grow corn the N:P ratio needs to be converted to 8:1. The process 200 of producing fertilizer with custom N:P ratio and composition is described with reference to FIG. 2. The raw manure is collected in a manure pit (202) and then is introduced into a mixing tank where it is stirred to produce a homogenized mixture and then strained to remove excess water (204). Next the manure passes through a screw press, where component A is extracted (206). In the next step a flocculant is added to the manure solution (208) and then the manure solution enters a mixing tank 108 where it is further diluted with KOH and water to 1:1 ratio (210). The KOH reacts with the phosphorus in the manure solution to form KPO4, which is a stable fertilizer. The stable fertilizer KPO4 (component B) is extracted at this stage (210). The remaining solution passes through an electrocoagulation station where component C is separated (212) and then through a clarifier 112 where component D is extracted (214).

Finally the remaining water E is clean enough and is discharged to the fields for irrigation purposes (216). A percentage x from component A (220), a percentage y from component B (222), a percentage z from component C (224), a percentage w from component D (226) and a percentage r from component E are mixed to produce a fertilizer with custom composition and N:P ratio (228). If necessary, an additional stabilizing material, such as CC or lime, is added to form a stable time-release fertilizer.

In one example, component C that contains 45% P(400 mg/L) and 10% N (560 mg/L) is mixed with component D that contains 0% P and 40% N (2240 mg/L) to produce a fertilizer with a N:P ratio of 7:1 (2800 mg/L of N and 400 mg/L of P). In another example, component A that contains 20% N (1120 mg/L) and 15% P (130 mg/L) is mixed with component D that contains 40% N (2240 mg/L) and 0% P to produce a fertilizer with a N:P ratio of 30:1 (3370 mg/L of N and 130 mg/L of P). Similarly any type of N:P ratio is generated by mixing the appropriate component A, B, C, or D at the appropriate percentages.

Table 1 summarizes the N and P content of component A, B, C and D extracted from the screw press, plate filter press, electrocoagulation station, and clarifier, respectively.

TABLE 1

| | N (mg/L) | P (mg/L) | Solubility |
|---|---|---|---|
| Component A | 1120 | 130 | Soluble |
| Component B | 1700 | 360 | Partially |
| | | | soluble |
| Component C | 560 | 400 | Non-soluble |
| Component D | 2240 | 0 | Non-soluble |

By varying the amount of added flocculants the amount of N and P content of components A, B, C, D and E may be varied between minus 5% or 7% to plus 5% or 7%.

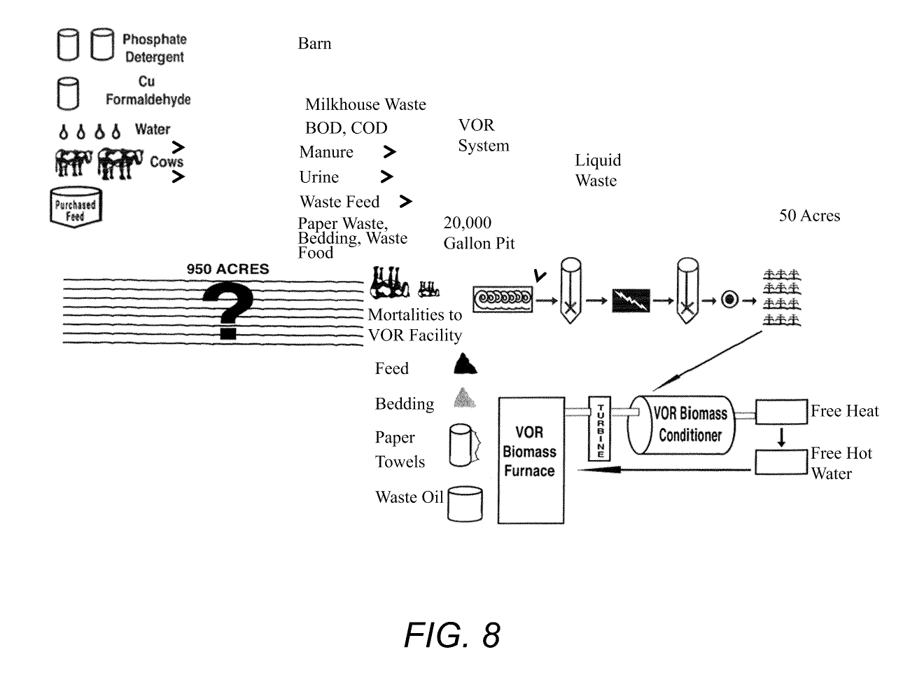

The described manure reclamation system 110 is used in a novel sustainable farming process 300, shown in FIG. 5 and FIG. 8. Referring to FIG. 5, manure 95 from dairy farms is processed with the manure reclamation system 100 to produce solid manure components 160 and clarified water 180. Solid manure components 160 include fertilizer 162, fodder/bedding material 164, and biomass 166. Fertilizer 162 and clarified water 180 are used to fertilize and irrigate the farming soil. Fodder 165 is used in the dairy farms as a bedding material for the animals or as a feed source. Biomass 166 is further compacted and pelletized and is used as a fuel source for running the drier 140 and other farming equipment and processes that require energy. The farming process of FIG. 5 reduces air and water pollution associated with farming and provides significant financial benefits, as shown in FIG. 8. Air pollution is reduced due to the elimination of the following sources. No fossil fuels are used for the delivery of bedding and oil to the farm and for spreading of the unprocessed manure and for delivering of urea. No fossil fuel is used for heating hot water for the washing the milk house. CH4 and CO2 pollution is reduced because unprocessed diary manure is not spread in the farm. Processing of the manure inside the barn reduces the spreading of the potent greenhouse gas NOX. The conversion of nitrogen to ammonia is prevented and odors associated with this process are eliminated. In addition to bad odors, bacteria, viruses, cysts and zoonotic creatures are eliminated. Water pollution is reduced due to the elimination of the following sources. Phosphorus pollution is eliminated from all aspects of the process. Copper and formaldehyde are eliminated from the foot wash. Nitrogen pollution of the surface water is reduced. Water pollution due to rotting carcasses is eliminated. Bacteria, viruses, cysts and zoonotic creatures are eliminated in the watershed. Biochemical (BOD) and chemical (COD) pollution of surface water from manure and milk waste is eliminated. The spreading of antibiotics, vitamins and hormones to surface water is reduced. The financial benefits of the farming process of FIG. 5 are due to the elimination of the costs for spreading unprocessed manure, generating heat from the biomass for heating farm buildings and water, reduction of paper waste, elimination of the costs for bedding material and fertilizer and benefits from the sale of bedding and fertilizer. The average financial benefit for a dairy farm of 500 milking cows is about $200,000 per year.

Other embodiments are within the scope of the following claims. For example, manure may be from cattle, poultry, sheep, pig or any other animal. The flocculant may be added at any of the process stations including the mixing tank, the pre-thickener, the electrocoagulation or the clarifier. Manure 95 may be introduced into the manure mixing tank 102 directly from the barn 90. Instead of KOH, calcium hydroxide Ca(OH)2 or lime can be used in the dilution tank 108. This results in the formation CaPO4, which is also no-soluble and is separated at the clarifier as component D.

Several embodiments of the present invention have been described. Nevertheless, it will be understood that various modifications may be made without departing from the spirit and scope of the invention. Accordingly, other embodiments are within the scope of the following claims.

What is claimed is:

1. A system for processing liquid manure comprising a series arrangement of a plurality of equipment said arrangement comprising:
first equipment for transferring said liquid manure into an input station;
second equipment for separating a first manure component and a first overflow liquor from said liquid manure at a first processing station;
third equipment for adding a flocculant material to said first overflow liquor at said first processing station;
fourth equipment for mechanically separating a second manure component and a second overflow liquor from said first overflow liquor at a second processing station;
fifth equipment for performing direct current electrocoagulation cleaning of said second overflow liquor at a third processing station and separating a third manure component and a third overflow liquor;
sixth equipment for performing clarifying cleaning of said third overflow liquor at an output station and separating a fourth manure component and water, wherein said sixth equipment comprises an outer container, an inner container contained within said outer container and having a bottom communicating with said outer container's bottom, means for transferring said third overflow liquor into said inner container, means for centrifuging said third overflow liquor in said inner container, means for extracting said fourth manure component from said centrifuged third overflow liquor through said inner container bottom, means for depositing said extracted fourth manure component at the bottom of said outer container, means for extracting said water from said centrifuged third overflow liquor and means for pushing said extracted water to the sides of the outer container in the space between said inner and outer container;
seventh equipment for drying any of said manure components and producing dried manure components, wherein said drying equipment comprises a stationary inner container surrounded by a rotating outer container, means for introducing hot air in the space between the inner container and the outer container, means for transferring said manure components into said inner container, means for rotating said outer container around and concentrically with said inner container and means of generating hot air, and wherein said means for generating hot air comprise a generator fueled by burning said dried manure components.

2. The system of claim 1 further comprising equipment for homogenizing said liquid manure at said input station.

3. The system of claim 1 further comprising equipment for discharging said water from said output station.

4. The system of claim 1 wherein said flocculant material comprises a complex carbohydrate compound.

5. The system of claim 4 wherein said complex carbohydrate compound comprise one of Fycosyllactose (C₁₈H₃₂O₁₅), Difucosyllactose (C₂₄H₄₂)₁₉), Lacto-N-tetraose (C₂₆H₄₅NO₂₁), Lacto-N-fucopentaose I (C₃₂H₅₅NO₂₅), Lacto-N-difucohexaose I (C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₉H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3, Oligomannose-8D1D2 (C₆₄H₁₀₈N₂O₅₁), Oligomannose-8D2D3, Oligomannose-9 (C₇₀H₁₁₈N₂O₄₆), Asialo-biantennary (C₆₂H₁₀₄N₄O₄₆), Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, or Maltotriose

6. The system of claim 1 wherein said second equipment for separating a first manure component comprises a screw press.

7. The system of claim 1 wherein said fourth equipment for separating a second manure component comprises a plate filter press.

8. The system of claim 1 where said flocculant comprise one of lime, iron, aluminum, wollostonite, calcium, starches, proteins, gelatin, animal glue, polymeric compounds or food grade polymers.

9. The system of claim 1 further comprising equipment for thickening said liquid manure.

10. The system of claim 1 wherein said first manure component comprises about 15 percent soluble phosphorus and about 20 percent soluble nitrogen.

11. The system of claim 1 wherein said second manure component comprises about 40 percent partially soluble phosphorus and about 30 percent partially soluble nitrogen.

12. The system of claim 1 wherein said third manure component comprises about 45 non-soluble phosphorus and about 10 percent non-soluble nitrogen.

13. The system of claim 1 wherein said fourth manure component comprises about 40 percent non-soluble nitrogen and no phosphorous.

14. The system of claim 1 wherein said arrangement further comprises eighth equipment for adding a stabilizing component to any of said manure components and wherein said stabilizing component is one of lime, wollostonite, calcium carbonate, complex carbohydrates, or calcium.

15. The system of claim 14 wherein said arrangement further comprises ninth equipment for mixing a first amount of said first manure component, a second amount of said second manure component, a third amount of said third manure component and/or a fourth amount of said fourth manure component to obtain a fertilizer comprising a desired nitrogen to phosphorous ratio.

16. An apparatus for drying wet solid manure and producing dried manure, said apparatus comprising a stationary inner container surrounded by a rotating outer container, means of generating hot air, means for introducing said hot air in the space between the inner container and the outer container, means for transferring said wet solid manure into said inner container, wherein said outer container rotates around and concentrically with said inner container, and wherein said means for generating hot air comprise a generator fueled by burning said dried manure.

17. The apparatus of claim 16 further comprising means for generating vacuum in said inner container.

18. A sustainable farming process comprising:
processing manure with the system of claim 1 thereby producing said first, second, third and fourth manure components, clarified water and dried manure components;
mixing a first amount of said first manure component, a second amount of said second manure component, a third amount of said third manure component and/or a fourth amount of said fourth manure component to obtain a custom fertilizer comprising a desired nitrogen to phosphorous ratio;
fertilizing farming soil with said custom fertilizer;
irrigating said farming soil with said clarified water; and
burning said dried manure components in a generator for generating power.
